(19) United States
(12) Patent Application Publication
(10) Pub. No.: US 2011/0099314 A1
(43) Pub. Date: Apr. 28, 2011

(54) Method for Operating a Trip Recorder of a Motor Vehicle and a Trip Recorder for Performing the Method

(75) Inventors: Klaus Hoffmann, Villingen-Schwenningen (DE); Horst Näther, Villingen-Schwenningen (DE)

(73) Assignee: Continental Automotive GmbH, Hannover (DE)

(21) Appl. No.: 12/673,130

(22) PCT Filed: Jul. 15, 2008
(86) PCT No.: PCT/EP08/59212

§ 371 Date: Feb. 11, 2010

(30) Foreign Application Priority Data
Aug. 13, 2007 (DE) 10 2007 038 229.6

(51) Int. Cl. G06F 13/00

(52) U.S. Cl. 710/301

(57) ABSTRACT

A trip recorder, a memory card or a cleaning card being passed by a reading device by an electric motor drive. The trip recorder attempts to establish communication with the inserted card. If no communication can be established, the reader device or the memory card is dirty, or the cleaning card is inserted in the trip recorder. In case of a failed attempt at communication, the electric motor drive moves the inserted card past the reader device repeatedly removing potential contamination.

### PRIORITY CLAIM

This is a U.S. national stage of application No. PCT/EP2008/059212, filed on Jul. 15, 2008., which claims priority to the German Application No.: 10 2007 038 229.6, filed: Aug. 13, 2007 the content of both incorporated herein by reference.

### BACKGROUND OF THE INVENTION

1. Field of the Invention

The invention relates to a method for operating a trip recorder, in which, following insertion of a memory card into a slot in the trip recorder, a drive for fully drawing-in the memory card is started and an attempt is then made to establish communication between the memory card, which is fully drawn into the slot, and the trip recorder. The invention also relates to a trip recorder for performing the method, comprising an electronic device for collecting and evaluating data, comprising a slot for accommodating a memory card, and comprising a read device for reading data from the memory card.

2. Prior Art

Trip recorders for motor vehicles, in particular for heavy goods vehicles, detect and evaluate data relating to a journey and to a driver of the motor vehicle and are known in practice. The memory card has a chip with contact areas and is used, at least to store the data relating to the driver, which data is generated in the trip recorder.

If the memory card if dirty or damaged, the data can no longer be transmitted and, in the worst-case scenario, this leads to a relatively large amount of data being lost.

In the case of memory cards which have a chip, the idea of monitoring the transmission of data and, when there is a fault in the transmission of data, moving the memory card a short way out of the slot and then drawing said memory card into the slot again has already been thought of. In the process, spring contacts in the device rub across the contact areas and remove any dirt which may be present on the memory card.

One idea could be to provide a memory card with a cleaning surface and insert said memory card into the trip recorder. However, since the read device can not be read and cleaned at the same time, such a memory card with a cleaning surface can be used only when communication between the read device in the trip recorder and the memory in the memory card is intact. In addition, this refinement requires a specific cleaning cycle which leads to increased expenditure on design.

### SUMMARY OF THE INVENTION

The invention is based on providing a method for operating a trip recorder with which the read device can be cleaned in a particularly simple manner. Furthermore, a trip recorder is to be provided for performing this method.

The first-mentioned problem is solved, according to one embodiment of the invention, in that, when there is no communication between the memory card and the trip counter, the drive is activated to move the memory card a short way out of the slot and back in again, and in that communication is then re-establish between the memory card, which is inserted into the slot, and the trip counter, and in that the drive is also activated for any card without a memory.

Due to this design, the trip recorder treats any card with which communication cannot be established as if it were a memory card. Since the card, which is inserted into the slot does not have to be recognized, the method according to the invention does not lead to an increase in the structural expenditure on the trip recorder. According to the invention, a special cleaning cycle does not need to be provided. This leads to particularly simple cleaning of the read device.

A further contribution is made to simplifying the method according to one embodiment the invention if a cleaning card with a cleaning surface which is appropriately designed to clean the read device is provided for cleaning contacts of the trip recorder, the cleaning card producing faulty communication with the trip recorder. The faulty communication is used to activate the drive of the card and therefore to clean the read device and/or the memory card. If the memory card is in the form of a memory card and the read device correspondingly has spring contacts, the contacts of the memory card are cleaned by friction. Instead of the contents of the memory card, the cleaning card can also be provided with a wiping means to clean the spring contacts of the read device. In this case, activation of the drive leads to cleaning of the read device.

When said read device is very dirty, the method according to one embodiment the invention permits particularly thorough cleaning of the read device if the drive for drawing the memory card or the cleaning card out of the slot and back into the slot is activated twice in immediate succession. If the read device of the trip counter is not adequately cleaned with a single movement, cleaning by the second movement is quicker than when an attempt is made to establish communication after the first movement of the memory card or the cleaning card.

According to another embodiment of the invention, continuous movement of the memory card or the cleaning card when communication cannot be established is avoided in a simple manner if the memory card or the cleaning card is ejected from the slot after a stipulated number of futile attempts at establishing communication between the memory card and the device and subsequent activation of the drive.

The method according to one embodiment of the invention permits adequate cleaning of read devices which exhibit a normal degree of soiling if the number of attempts to establish communication and subsequent movement of the memory card or cleaning card is two.

The second-mentioned problem, specifically that of providing a trip recorder of the type mentioned in the introduction for performing the method, comprising an electronic device for collecting and evaluating data comprising a slot for accommodating a memory card or a cleaning card, and comprising a read device for reading data from the memory card or the cleaning card, is achieved, according to one embodiment of the invention, in that the slot has an electromotive drive for the memory card or the cleaning card and a control device for the electromotive drive, and when the control device has a memory for the conditions and the number of stipulated movements of the memory card or the cleaning card.

Due to design, the trip recorder has all the components with which the memory card is drawn in and moved out again. The movement is controlled by the control device which is present in any case. The conditions for the method and the number of movements are stored in the memory. Due to the invention, an additional device for distinguishing between the memory card and the cleaning card is not required. As a result, the trip recorder is of particularly simple construction and permits particularly reliable transmission of the data.

### BRIEF DESCRIPTION OF DRAWINGS

The invention permits numerous embodiments. In order to further explain its basic principle, one of said embodiments will be explained in greater detail below and is illustrated in the drawings, in which

FIG. 1 is a schematic representation of a trip recorder containing a memory card, and

FIG. 2 is a flowchart of the method according to the invention for cleaning a read device from FIG. 1.

### DETAILED DESCRIPTION OF THE PREFERRED EMBODIMENTS

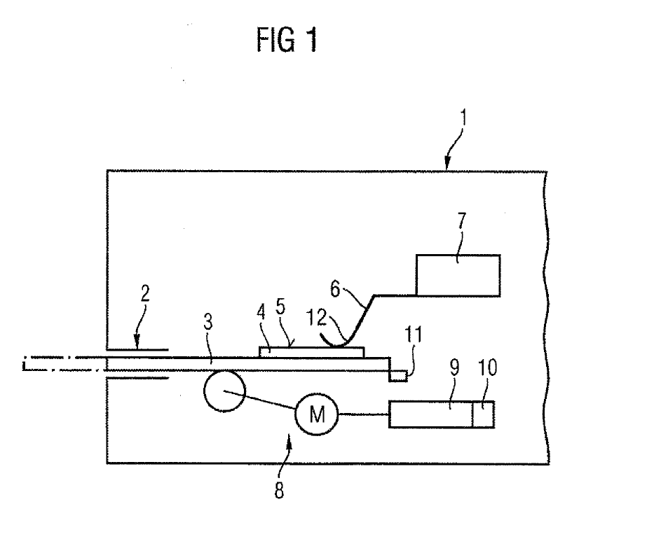

FIG. 1 is a sectional illustration of a tachograph or trip recorder 1 comprising a slot 2 for accommodating a memory card or a cleaning card 3. The cleaning card 3 has a felt pad 4 with a cleaning surface 5. A read device 6 is prestressed against the cleaning surface 5 by way of spring contacts 12 of the trip recorder. To simplify the drawing, only one spring contact 12 is illustrated. The spring contacts 12 are connected to an electronic device 7 for collecting and evaluating data, The cleaning card 3 can be drawn into the slot 2 and ejected from said slot by an electromotive drive 8. The presence of any card 3 which is inserted into the slot, is detected by a contact switch 11. In the drawing, dash-dotted lines illustrate the memory card 3 in a position in which card 3 is moved a short way out of the slot 2 and in which the contact switch 11 is just operated. The electromotive drive 8 is activated by a control device 9. The control device 9 has a memory 10 for conditions and a number of stipulated movements of the memory card 3 by the electromotive drive 8.

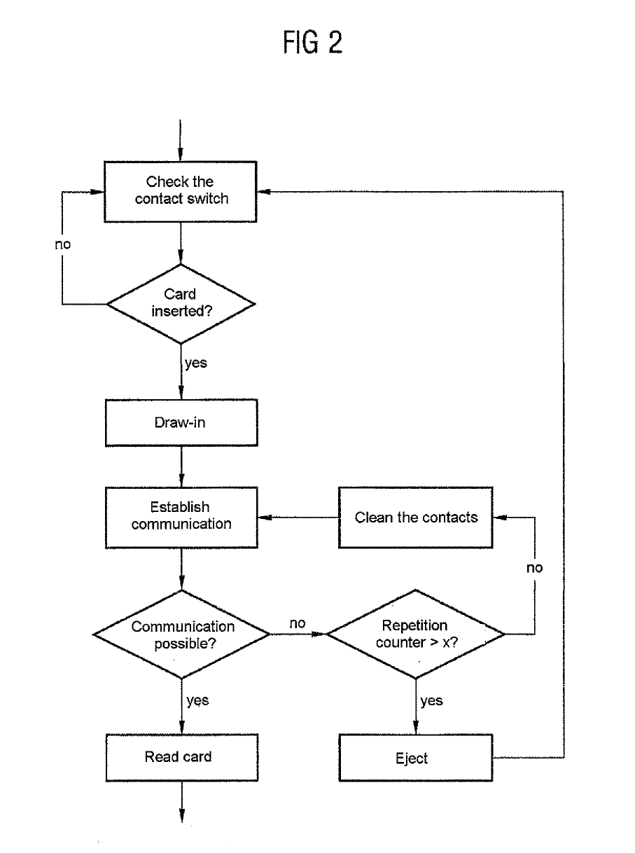

FIG. 2 is a flow chart for performing a method for cleaning the read device 6 by the cleaning card 3 of FIG. 1. The method is started by inserting the cleaning card 3 into the slot 2 in the trip recorder 1. In the first step, the position of the contact switch 11 is checked. At the same time, a counter is set to zero. If the contact switch 11 has been operated by the cleaning card 3, the cleaning card 3 is drawn-in in a second step. Then, in a third step, communication is established between the electronic drive 8 and the cleaning card 3. However, since the cleaning card 3, in contrast to a memory card, cannot establish communication, the read device 6 is cleaned in a fourth step by the electromotive drive 8 from FIG. 1 being activated and the cleaning card 3 being moved a short way out of the slot 2 and reinserted, for example twice. In this case, the repetition counter is incremented by the value 1. The third method step is then executed again with the attempt to establish communication. The cleaning card 3 generates a further failure in communication, as a result of which the read device 6 is cleaned again and the repetition counter is incremented by the value 1. Communication is then tested again and, in the event of another failure, the cleaning card 3 is ejected in a last step.

If, instead of a cleaning card 3, a memory card is inserted into the slot 2, a fault in communication is likewise produced when a read device 6 is dirty or a memory card is dirty. Therefore, the memory card is ejected after being inserted and withdrawn, like the cleaning card 3, or the dirt on the read device 6 or the memory card has been removed and the memory card can be read.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A method for operating a trip recorder of a motor vehicle, comprising:
inserting a card into a slot in the trip recorder, the card comprising one of a memory card and a cleaning card;
starting a drive for fully drawing-in the card;
attempting to establish communication between the fully drawn-in card and the trip recorder;
activating the drive at least once to move the card a short way out of the slot and back in again when there is no communication between the card and the trip counter;
after activating the drive at least once, attempting to establish communication between the card, which is inserted into the slot, and the trip counter; and
activating the drive to eject the card if communication cannot be established.

8. The method as claimed in claim 7, wherein the cleaning card comprises a cleaning surface configured to clean the read device by cleaning contacts of the trip recorder, the cleaning card producing faulty or no communication with the trip recorder.

9. The method as claimed in claim 7, wherein the drive for drawing-in the card out of the slot and back into the slot is activated twice in immediate succession.

10. The method as claimed in claim 7, wherein the card is ejected from the slot after a stipulated number of futile attempts at establishing communication between the card and the device.

11. The method as claimed in claim 7, wherein a number of attempts to establish communication and subsequent movement of the card is two.

12. A trip recorder comprising:
an electronic device for collecting and evaluating data;
a slot for accommodating a card, the card comprising at least one of memory card or a cleaning card;
a read device for reading data from the card;
an electromotive drive configured to:
fully draw-in the card into the slot,
move the card a short way out of the slot and back in again, and
eject the card;
a control device configured to control the electromotive drive to:
fully draw-in the card into the slot,
move the card a short way out of the slot and back in again if no communication is read from the card by the read device at a fully drawn-in position of the card, and
eject the card; and
a memory configured to store conditions and a number of stipulated movements of the card.

13. The method as claimed in claim 8, wherein the drive for drawing-in the card out of the slot and back into the slot is activated twice in immediate succession.

14. The method as claimed in claim 8, wherein the card is ejected from the slot after a stipulated number of futile attempts at establishing communication between the card and the device.

15. The method as claimed in claim 10, wherein the stipulated number of attempts to establish communication and subsequent movement of the card is two.

16. The trip recorder as claimed in claim 12, wherein the stipulated number of attempts to establish communication and subsequent movement of the card is two.

17. The method as claimed in claim 7, wherein the same method is performed for the memory card and the cleaning card.

18. The trip recorder as claimed in claim 12, wherein the control device provide the same control for the memory card and the cleaning card.
